(19) United States
(12) Patent Application Publication
(10) Pub. No.: US 2008/0137131 A1
(43) Pub. Date: Jun. 12, 2008

(54) Host-Assisted Document Printing From Mobile Devices

(76) Inventors: Barry Richard Cavill, Versailles, KY (US); William Henry Reed, Lexington, KY (US); Maini Helena Williams, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/609,008

(22) Filed: Dec. 11, 2006

(51) Int. Cl. G06F 15/00

(52) U.S. Cl. 358/1.15

(57) ABSTRACT

A method for performing host-assisted document printing from a mobile device in an imaging system having a printer communicatively coupled to a host includes establishing a direct communication link from the mobile device to the printer; transferring a native document file from the mobile device to the printer; sending the native document file from the printer to the host; processing the native document file by a print application program running on the host to generate print data corresponding to the native document file; processing the print data through a printer driver associated with the printer; and printing the print data at the printer.

### BACKGROUND OF THE INVENTION

1. Field of the Invention

The present invention relates to printing and, more particularly to host-assisted document printing from a mobile device.

2. Description of the Related Art

High speed data support (i.e., G3 or third generation services) for mobile phones and other mobile information devices allows the downloading of documents from network servers and the internet. With such devices, people can conveniently access vast amounts of information almost anywhere and anytime without carrying a heavy computer with them. However such documents display poorly on the small screens of the mobile devices.

Documents are typically stored in native file formats, such as for example Adobe® Acrobat® (PDF) or Microsoft® formats, e.g., Word (DOC), PowerPoint® (PPT) and Excel® (XLS) which are easily viewed, but must be processed into data suitable for printing. For competitive reasons like increased cost and decreased battery life, mobile device vendors currently do not have or wish to include the capability to support the processing of standard documents for printing. For example, such mobile devices do not include application software, e.g., Acrobat, Word, PowerPoint, Excel, etc., or the printer driver necessary to send a document in a printable format to a printer. Also, including support for multiple printers might require a print driver for each printer or printer type. While documents could be downloaded to a host computer, typically such host computers include security features e.g., passwords, which may prevent the processing of a document for printing, even if the document can be downloaded from the mobile device to the host. Also, the majority of personal printers are low-cost devices incapable of standalone processing of document files.

### SUMMARY OF THE INVENTION

The present invention facilitates the printing of a native document file supplied by a mobile device on a host-assisted printer.

The invention, in one term thereof, is directed to a method for performing host-assisted document printing from a mobile device in an imaging system having a printer communicatively coupled to a host. The method includes establishing a direct communication link from the mobile device to the printer; transferring a native document file from the mobile device to the printer; sending the native document file from the printer to the host; processing the native document file by a print application program running on the host to generate print data corresponding to the native document file; processing the print data through a printer driver associated with the printer; and printing the print data at the printer.

The invention, in another form thereof, includes a method for performing host-assisted document printing from a mobile device in an imaging system having a plurality of printers each communicatively coupled to at least one host The method includes establishing a direct communication link from the mobile device to each printer of the plurality of printers; identifying native file types that each printer of the plurality of printers is configured to receive; selecting a particular printer of the plurality of printers that is configured to receive a native file document of a native file type supported by the particular printer transferring the native document file from the mobile device to the particular printer; sending the native document file from the particular printer to the host; processing the native document file by a print application program running on the host to generate print data corresponding to the native document file; processing the print data through a printer driver associated with the particular printer; and printing the print data at the particular printer.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention.

FIG. 2 is a flowchart of a method for performing host-assisted document printing from a mobile device in an imaging system

FIG. 3 is a diagrammatic depiction of another embodiment of an imaging system embodying the present invention.

FIG. 4 is a flowchart of alternative steps for use in conjunction with the method of FIG. 2 in accordance with the embodiment of FIG. 3.

FIG. 5 is a diagrammatic depiction of another embodiment of an imaging system embodying the present invention.

FIG. 6 is a flowchart of alternative steps for use in conjunction with the method of FIG. 2 in accordance with the embodiment of FIG. 5.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

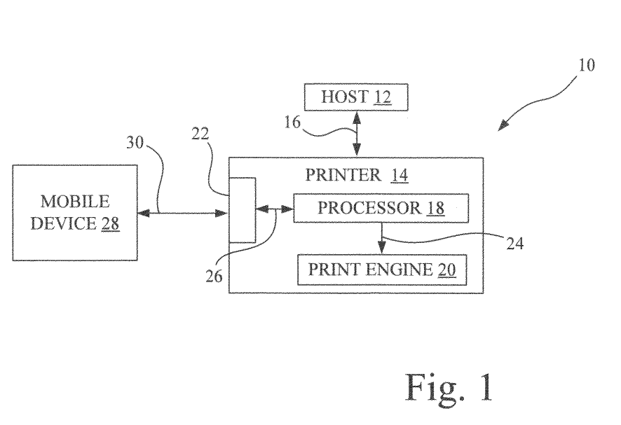

Referring to FIG. 1, there is shown a diagrammatic depiction of an imaging system 10. Imaging system 10 may include a host 12 and a printer 14. Printer 14 communicates with host 12 via a communications link 16. Communications link 16 may be established by a direct cable connection, wireless connection or by a network connection such as for example an Ethernet local area network (LAN). Alternatively, printer 14 may be incorporated into a multifunction machine that includes standalone copying and facsimile capabilities, in addition to optionally serving as a printer.

Host 12 may be, for example, a personal computer including an input/output (I/O) device such as keyboard and display monitor. Host 12 further includes a processor, input output (I/O) interfaces, memory, such as RAM, ROM NVRAM, and a mass data storage device, such as a hard drive, CD-ROM and/or DVD units. Stored in memory is one or more document software applications, e.g., Acrobat, Word, PowerPoint, Excel, etc., which generates and/or processes native document files to generate print data corresponding to the native file format. A native document file is a file in a respective document file format (type), e.g., for Adobe Acrobat, PDF; for Word, DOC; for PowerPoint, PPT; and for Excel, XLS.

Also, host 12 may include in its memory a software program including program instructions that function as a printer driver for printer 14. Alternatively the printer driver may be incorporated, in whole or in part, in printer 14.

In the embodiment of FIG. 1, printer 14 includes, for example, a processor 18 a print engine 20, and a communication port 22. The printer driver facilitates communication between printer 14 and host 12, and provides formatted print data to print engine 20

Processor 18 includes a processor unit and associated memory, and may be formed as an Application Specific Integrated Circuit (ASIC). Processor 18 communicates with host 12 via communications link 16. Processor 18 communicates with print engine 20 via a communications link 24. Processor 18 communicates with communication port 22 via a communications link 26. Communications links 24 and 26 may be established, for example, by using standard electrical cabling or bus structures, or by wireless connection. In some embodiments, all or a port ion of the printer driver may reside in processor 18.

Print engine 20 may be, for example, an ink jet print engine configured forming an image on a sheet of print media, such as a sheet of paper, transparency or fabric. Print engine 20 may include, for example, a reciprocating printhead carrier that is mechanically and electrically configured to mount and carry at least one micro-fluid ejection device, e.g., an ink jet printhead, coupled in fluid communication with an ink source.

A mobile device 28 is communicatively coupled to communication port 22 of printer 14 via a communication link 30. Mobile device 28 may be, for example, a mobile telephone (e.g., a cell phone), personal digital assistant (PDA), a notebook computer, etc. Note that there may be instances where the communication link 30 may be of the same form and substance as the communication link 16 (e.g., a 802.11X wireless connection) that may in instances be part of the same network communication method.

Communication port 22 is configured to accommodate either or both of wired or wireless communication with mobile device 28 via communication link 30. For example, communication link 30 may be a wireless or wired connection, such as any of a variety of standard connections including: Bluetooth, 802.11x, infrared, wireless Ethernet, ultra-wideband, USB cable, IEEE 1394 (e.g. Firewire), wired Ethernet, memory card, and others Appropriate communication protocols, including for example BPP, SPP, OBEX, Pictbridge, DPOF, IrDA, UPNP and Wi-Fi, exist for these connections that allow service discovery and file exchange between mobile device 28 and printer 14.

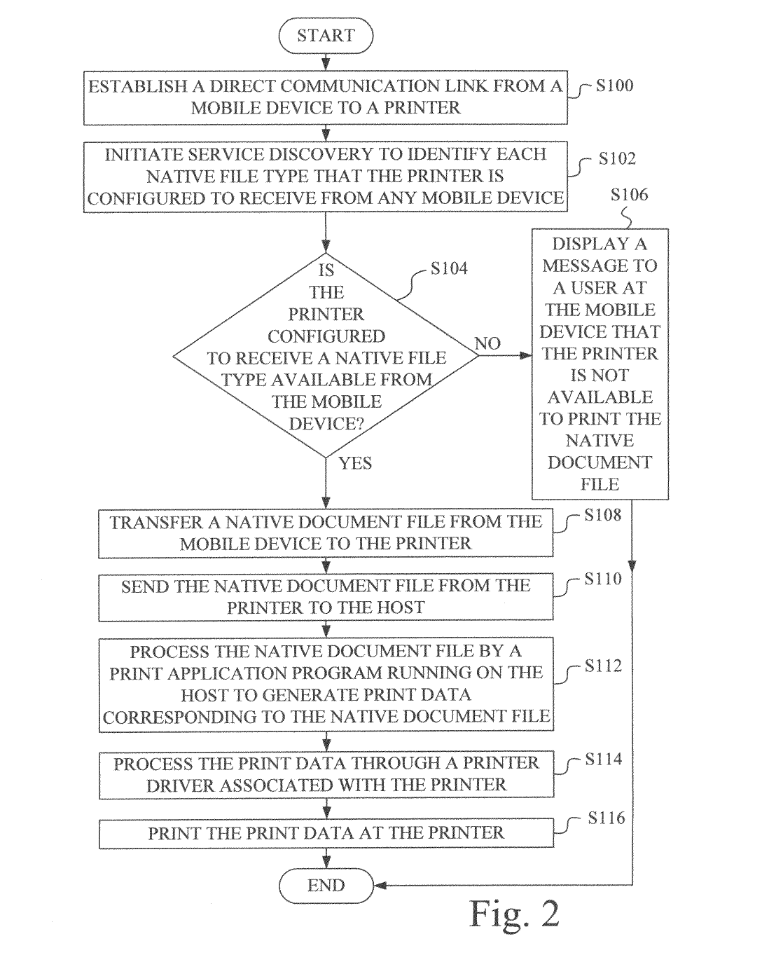

FIG. 2 is a flowchart of a method for performing host-assisted document printing from a mobile device in an imaging system having a printer communicatively coupled to a host, in accordance with an embodiment of the present invention. The method of FIG. 2 is initiated by a user of mobile device 28, and controls printing from mobile device 28 while printer 14 and host 12 function as clients providing a printing service for mobile device 28.

At step S100, a direct communication link is established from a mobile device, e.g., mobile device 28 to a printer, e.g., printer 14 As used herein, the term “direct communication link” is a communication link established between, for example, mobile device 28 and printer 14 without any intermediary external processing computer that transfers files from the mobile device to printer 14.

At step S102, a service discovery may be initiated by mobile device 28 to identify each native file type that printer 14 is configured to receive from any mobile device. For example, mobile device 28 may issue a request to printer 14 for printer 14 to provide a list of native file types that are supported by printer 14 in conjunction with host 12. The native file type may be, for example, for Adobe Acrobat, PDF; for Word, DOC; for PowerPoint, PPT; and for Excel, XLS The native file type may be other applications that may support printing. Selection of these applications may be facilitated by utilization of the file type association as specified in the host to permit identification of an application that may support printing of a specific file type.

At step S104, it is determined whether printer 14 is configured to receive a native file type available from mobile device 28. For example, the list of native file types that are supported by printer 14 may be supplied by a file process in processor 18 of printer 14, which in turn may then deliver this information to mobile device 28.

Steps S102 and S104 may be optional, in that rather than perform discovery, mobile device 28 may assume that printer 14 is configured to accept a native file document being sent in the native file format. If, however, printer 14 is not so configured, then step S106 would be invoked.

Also, if the determination at step S104 is NO, then the process proceeds to step S106.

At step S106, a message to a user is generated and displayed at mobile device 28 to indicate to the user that printer 14 is not available to print the native document. This user message may also/alternatively be displayed on printer 14.

If the determination at Step S104 is YES, then the process proceeds to step S108.

At step S108 a native document file is transferred from mobile device 28 to printer 14. For example, the user of mobile device 28 may select a native document file (or files) for printing and transmit a print request to printer 14 through the communication method established. This print request may include the native document file to be printed directly, or may include a referenced location on mobile device 28 The print request may optionally include additional information to permit specification of print settings.

Processor 18 of printer 14 may also include a storage block where the native document files that are received from mobile device 28 are saved until a print application file (PAF) manager running on host 12 is ready to retrieve them from the storage, or the files may be uploaded from the storage at a later time.

At step S110, the native document file is sent from printer 14 to host 12. Processor 18 of printer 14 may include a file process and upload (FPU) manager that is configured to upload the file data of the native document file for processing by the PAF manager running on host 12, which is described in more detail below. In summary, the PAF manager is used to manage the transfer of the native document file from printer 14 to a location in the host where it may be obtained by the software application program running on host 12, and then initiate the printing process using the host application.

At step S112, the native document file is processed by a print application program running on host 12 to generate print data corresponding to the native document file. For example, processor 18 is in communication with a software print application program running on host 12. The print application program receives the native document file from printer 14, and starts a software application program (e.g., Acrobat, Word, PowerPoint, Excel, web browser, etc.) appropriate for the native file type of the native document file.

More particularly, the print application program on host 12 may include the print application file (PAF) manager, an associated software application program which is capable of translating the native document file to a printable form, and a printer driver. The PAF manager performs the following functions: (a) defines which native file types that are remotely printable using the applications installed on host 12, (b) initiates printing of the native document files delivered to installed applications, and (c) receives (or requests) file data and requests to print files from printer 14. In some embodiments, the print application program on host 12 may include the printer driver which delivers print commands and print data to printer 14.

After printer 14 is powered on, or the connection from host 12 to printer 14 is established, the PAF manager will examine the host system and identify those installed associated software applications which will permit reception of print requests for documents of the document file type that they support. The PAF manager will then either send this information to the FPU manager in processor 18 of printer 14 or respond to a request from printer 14 for that information.

At step S114, the print data is processed through a printer driver associated with printer 14. The printer driver may, for example, reside on host 12 as described immediately above, or may reside on printer 14.

At step S116, the print data is printed at printer 14. For example, the software application program running on host 12 may invoke print engine 20 through the printer driver.

These processes of steps 110 through 116 may run in the background of host 12, i.e., with no aspects of the execution of the method being obvious to a user at host 12, such as for example, with nothing being displayed on the monitor of host 12, and with no aspects of the execution of the method being obvious to a user at mobile device 28. Even with this host-assisted document processing, direct printing would appear to the user of mobile device 28 as a sustained process.

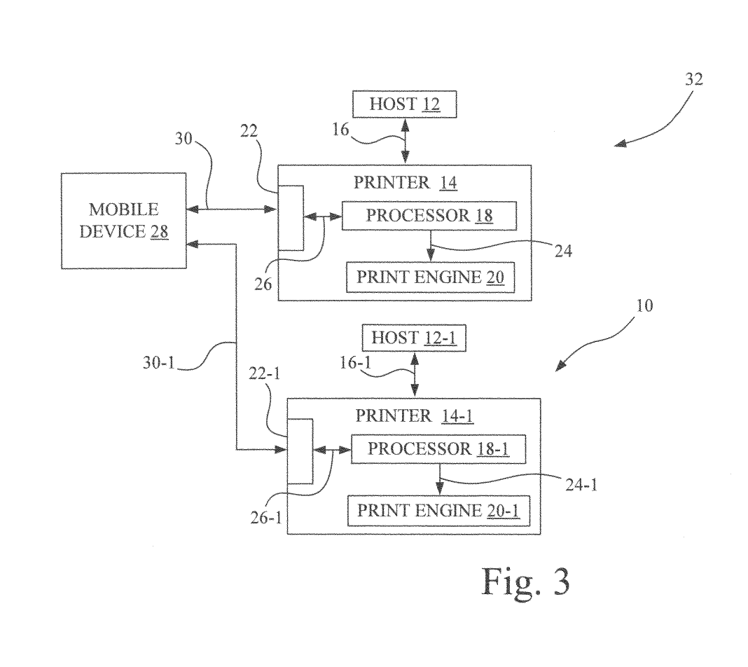

FIG. 3 is exemplary embodiment of an imaging system 32 that includes the components of imaging system 10, described above, and further includes a host 12-1 and a printer 14-1.

Host 12-1 may be configured like host 12, but may include different software applications from those of host 12. Stored in memory of host 12-1 is one or more document software applications, e.g., Acrobat, Word, PowerPoint, Excel, etc., which generates and/or processes native document files to generate print data corresponding to the native file format, e.g., for Adobe Acrobat, PDF; for Word, DOC; for PowerPoint, PPT; and for Excel, XLS. Also, host 12-1 may include in its memory a software program including program instructions that function as a printer driver for printer 14-1. Alternatively, the printer driver may be incorporated, in whole or in part, in printer 14-1.

In the embodiment of FIG. 3, printer 14-1 includes, for example, a processor 18-1, a print engine 20-1, and a communication port 22-1. The printer driver facilitates communication between printer 14-1 and host 12-1, and provides formatted print data to print engine 20-1. All or a portion of the printer driver may be located in host 12-1 or processor 18-1 of printer 14-1.

Processor 18-1 includes a processor unit and associated memory, and may be formed as an Application Specific Integrated Circuit (ASC). Processor 18-1 communicates with host 12-1 via communications link 16-1. Communications link 16-1 may be established by a direct cable connection, wireless connection or by a network connection such as for example an Ethernet local area network (LAN). Processor 18-1 communicates with print engine 20-1 via a communications link 24-1. Processor 18-1 communicates with communication port 22-1 via a communications link 26-1. Communications links 24-1 and 26-1 may be established, for example, by using standard electrical cabling or bus structures, or by wireless connection

Print engine 20-1 may be, for example, an ink jet print engine configured for forming an image on a sheet of print media. Print engine 20-1 may include, for example, a reciprocating printhead carrier that is mechanically and electrically configured to mount and carry at least one micro-fluid ejection device, e.g., an ink jet printhead, coupled in fluid communication with an ink source.

Mobile device 28 is communicatively coupled to communication port 22-1 of printer 14-1 via a communication link 30-1. Communication port 22-1 is configured to accommodate either or both of wired or wireless communication with mobile device 28 via communication link 30-1. Thus, mobile device 28 may be communicatively coupled to either or both of printers 14, 14-1.

In the embodiment of FIG. 3, for example, printer 14 and printer 14-1 may be configured to accept and process different file types. For example, printer 14 may be configured to accommodate the Microsoft Word (DOC) file type, whereas printer 14-1 may be configured to accommodate the Adobe Acrobat (PDF) file type.

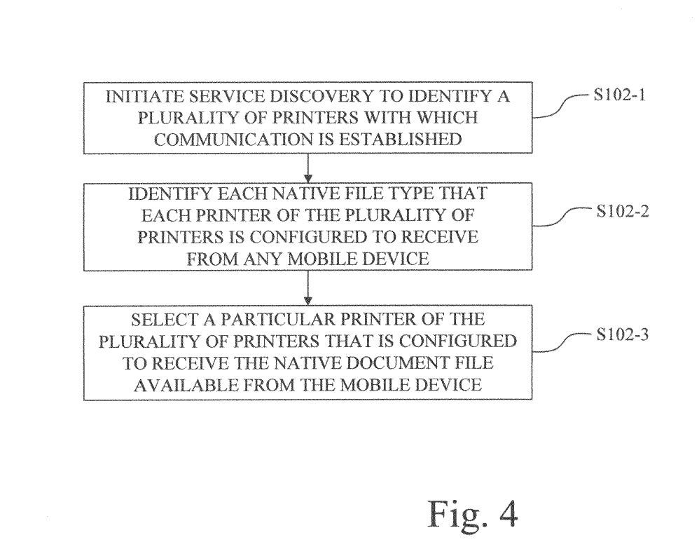

FIG. 4 shows a flowchart of alternative steps for use in conjunction with the method of FIG. 2, wherein step S102 of FIG. 2 is modified to accommodate a scenario, wherein mobile device 28 is communicatively linked to multiple printers. In this scenario, all other steps may be performed as described above with respect to FIG. 2, unless otherwise indicated.

At step S102-1, service discovery is initiated to identify a plurality of printers e.g., printers 14, 14-1 with which communication is established. This service discovery is initiated by mobile device 28.

At step S102-2, the service discovery identifies each native file type that each printer of the plurality of printers 14, 14-1 is configured to receive from any mobile device. For example, mobile device may display the native file types that may be accommodated by each of printers 14, 14-1.

At step S102-3, a particular printer of the plurality of printers is selected that is configured to receive the native document file of the native file type available from mobile device 28.

The process may then proceed to step S104. In this scenario, step S104 will be optional, as the result of the determination at step S104 will be YES. The process then may continue through step S116 of FIG. 2.

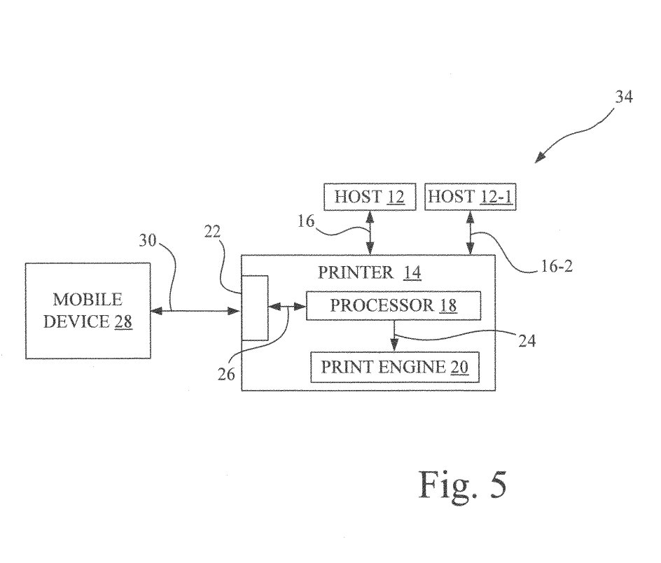

FIG. 5 is exemplary embodiment of an imaging system 34 that includes the components of imaging system 10, described above, and further includes host 12-1, described above, communicatively coupled to printer 14 via communications link 16-2. Communications link 16-2 may be established by a direct cable connection, wireless connection or by a network connection such as for example an Ethernet local area network (LAN).

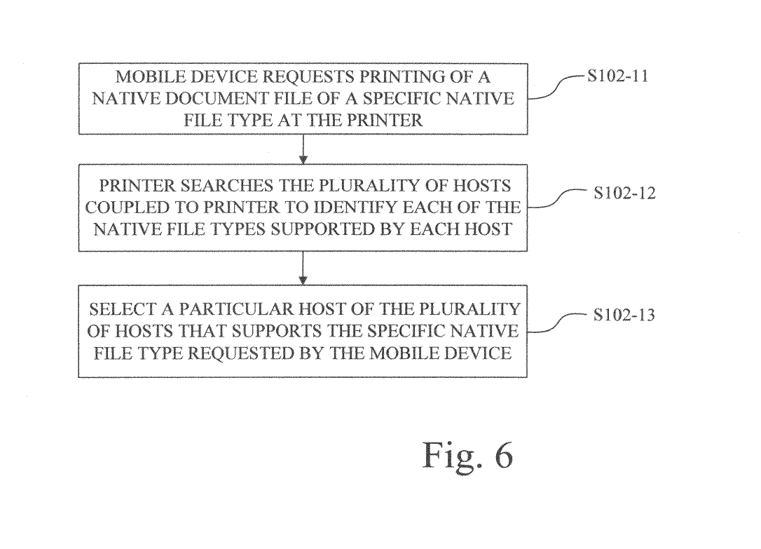

FIG. 6 shows a flowchart of alternative steps for use in conjunction with the method of FIG. 2, wherein step S102 of FIG. 2 is modified to accommodate a scenario, wherein printer 14 is communicatively linked to multiple hosts. In this scenario, all other steps may be performed as described above with respect to FIG. 2, unless otherwise indicated.

At step S102-1 mobile device 28 requests printing of a native document file of a specific native file type at printer 14.

At step S102-12, printer 14 searches the plurality of hosts coupled to printer 14, e.g., host 12 and host 12-1, to identify each of the native file types supported by each of host 12 and host 12-1. Within each host there is the capability to process native document files of a native document file type that is defined by the software application programs that are present in the respective host.

At step S102-13, a particular host of the plurality of hosts is selected that supports the specific native file type requested by mobile device 28, thus configuring printer 14 to receive the native document file of the native file type requested by mobile device 28.

For example, tie PAF manager within each host communicates with printer 14 when selected and identifies to printer 14 the supported native file types. Printer 14 may then choose one of the plurality of hosts, which in this example is one of host 12 and host 12-1, that supports printing of the native file type required according to a specified process or algorithm (e.g., first detected, most file types supported, fastest processor, fastest data path, etc.).

The process may then proceed to step S104. In this example, step S104 will be optional, as the result of the determination at step S104 will be YES. The process then may continue through step S111 of FIG. 2. If however, neither of host 12 or 12-1 supports the specific native file type requested by mobile device 28, then the process may proceed to step S106.

This disclosure has addressed the processing of native document files, but the print job request from mobile device 28 may also contain information about the print job (such as requested print quality, number of copies, and paper type). Thus, the print job information may be processed along with the native document file to improve print results. For example, print job properties might be selected by the user of mobile device 28 from options displayed at mobile device 28 based on the discovery of printer capability when communication is established between mobile device 28 and one or more printers.

While this invention has been described with respect to embodiments of the invention, the present invention may be further modified within the spirit and scope of this disclosure. This application is therefore intended to cover any variations, uses or adaptations of the invention using its general principles. Further, this application is intended to cover such departures from the present disclosure as come within known or customary practice in the art to which this invention pertains and which fall within the limits of the appended claims.

What is claimed is:

1. A method for performing host assisted document printing from a mobile device in an imaging system having a printer communicatively coupled to a host, comprising.
establishing a direct communication link from said mobile device to said printer;
transferring a native document file from said mobile device to said printer;
sending said native document file from said printer to said host;
processing said native document file by a print application program running on said host to generate print data corresponding to said native document file
processing said print data through a printer driver associated with said printer; and
printing said print data at said printer.

2. The method of claim 1, wherein said printer driver is resident in one of said host and said printer.

3. The method of claim 1, wherein said direct communication link from said mobile device to said printer is a wireless connection using a wireless communication standard.

4. The method of claim 1, wherein said direct communication link from said mobile device to said printer is a wired connection using a wired communication standard.

5. The method of claim 1, further comprising said mobile device initiating service discovery to identify each native file type that said printer is configured to receive from any mobile device.

6. The method of claim 5 wherein if said service discovery indicates that said printer is configured to receive a native file type available from said mobile device, said mobile device initiating said transferring of said native document file from said mobile device to said printer.

7. The method of claim 5, wherein if said service discovery indicates that said printer is not configured to receive a native file type available from said mobile device, said mobile device displaying a message to a user at said mobile device that said printer is not available to print said native document file.

8. The method of claim 5, wherein said service discovery includes identifying each native file type that each printer of a plurality of printers is configured to receive.

9. The method of claim 8, further comprising selecting a particular printer of said plurality of printers for receiving said native document file.

10. The method of claim 5, wherein native file types that are supported are identified by host file type associations which permit selection of an associated software application program in said host.

11. The method of claim 1, further comprising said mobile device initiating print settings to be used in the creation of printed output at said printer.

12. The method of claim 1, wherein said native document file is in one of Acrobat, Word, PowerPoint and Excel native file types.

13. The method of claim 1, wherein the performing of said method is initiated by said mobile device and said method operates with no aspects of the execution of said method being obvious to a user at said mobile device.

14. The method of claim 1, wherein said host is one of a plurality of hosts communicatively coupled to said printer, said host being selected by said printer as having a capability to process said native document file.

15. A method for performing host-assisted document printing from a mobile device in an imaging system having a plurality of printers each communicatively coupled to at least one host, comprising:
establishing a direct communication link from said mobile device to each printer of said plurality of printers;
identifying native file types that each printer of said plurality of printers is configured to receive;
selecting a particular printer of said plurality of printers that is configured to receive a native file document of a native file type supported by said particular printer;
transferring said native document file from said mobile device to said particular printer;
sending said native document file from said particular printer to said host;
processing said native document file by a print application program running on said host to generate print data corresponding to said native document file;
processing said print data through a printer driver associated with said particular printer; and
printing said print data at said particular printer.

16. The method of claim 15, wherein said printer driver is resident in one of said host and said particular printer.

17. The method of claim 15, wherein said direct communication link from said mobile device to said particular printer is a wireless connection using a wireless communication standard.

18. The method of claim 15, wherein said direct communication link from said mobile device to said particular printer is a wired connection using a wired communication standard.

19. The method of claim 15, wherein the performing of said method is initiated by said mobile device, and said method operates with no aspects of the execution of said method being obvious to a user at said mobile device.

20. The method of claim 15, wherein said native document file is in one of Acrobat, Word, PowerPoint and Excel native file types.

21. The method of claim 15, wherein said native file types that are supported are identified by host file type associations which permit selection of an associated software application program.

22. The method of claim 15, further comprising said mobile device initiating print settings to be used in the creation of printed output at said printer.
